(19) United States
(12) Patent Application Publication
(10) Pub. No.: US 2008/0232228 A1
(43) Pub. Date: Sep. 25, 2008

(54) SYSTEMS AND METHODS OF WRITING AND READING A FERRO-ELECTRIC MEDIA WITH A PROBE TIP

(75) Inventors: Donald Edward Adams, Pleasanton, CA (US); Robert N. Stark, Saratoga, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/688,806

(22) Filed: Mar. 20, 2007

(51) Int. Cl. G11B 9/00

(52) U.S. Cl. 369/126

(57) ABSTRACT

A system for storing information comprises a media including a ferroelectric layer, a tip arrangeable in electrically communicative proximity to the media, and circuitry to detect a polarization signal having a radio frequency. The polarization signal corresponds to changes in polarization of domains of the ferroelectric layer at a relative velocity of movement between the tip and the media, wherein a domain of polarization of the ferroelectric layer is information.

### TECHNICAL FIELD

This invention relates to systems for storing information.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Adding to this need for capacity is the confluence of personal computing and consumer electronics in the form of personal MP3 players, such as iPod®, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used. Consequently, there is a need for solutions which permit higher density data storage at a reasonable cost per megabyte.

### BRIEF DESCRIPTION OF THE DRAWINGS

Further details of the present invention are explained with the help of the attached drawings in which:

FIG. 1 is a schematic partial circuit diagram of a voltage mode AC-coupled front end for use in embodiments of systems and methods of storing information in accordance with the present invention.

FIG. 2; FIG. 2A is a cross-sectional view of an embodiment of a system including a tip arranged over a media with a ferroelectric layer in accordance with the present invention; FIG. 2B is an equivalent circuit for the tip and media of FIG. 2A; FIG. 2C is a perspective view of the system of FIG. 2A.

FIG. 3; FIG. 3A is a circuit diagram of the system of FIG. 1 with the equivalent circuit of FIG. 2B substituted for the tip and media; FIG. 3B is a plot of signal magnitude as a function of frequency.

FIG. 4 is a plot of noise as a function of the unguarded input capacitance for the circuit of FIG. 3A.

FIG. 5 is a schematic partial circuit diagram of a charge mode AC-coupled front end for use in embodiments of systems and methods of storing information in accordance with the present invention.

FIG. 6 is a circuit diagram of the system of FIG. 5 with the equivalent circuit of FIG. 2B substituted for the tip and media.

FIG. 7 is a plot of noise as a function of the unguarded input capacitance for the circuit of FIG. 6.

FIG. 8 is a schematic partial circuit diagram of a front end including a guard trace associated with a second read amplifier for use in embodiments of systems and methods of storing information in accordance with the present invention.

FIG. 9A is a plan view of a cantilever and tip assembly including the guard trace of FIG. 8.

FIG. 9B is a plan view of an alternative cantilever and tip assembly including the guard trace of FIG. 8.

FIG. 10 is a flowchart of an embodiment of a method of reading information from a ferroelectric media by detecting a spontaneous polarization of a ferroelectric media in accordance with the present invention.

FIG. 11 is a flowchart of an embodiment of a method of storing information as spontaneous polarization in a ferroelectric media in accordance with the present invention.

### DETAILED DESCRIPTION

Ferroelectrics are members of a group of dielectrics that exhibit spontaneous polarization—i.e., polarization in the absence of an electric field. Ferroelectrics are the dielectric analogue of ferromagnetic materials, which may display permanent magnetic behavior. Permanent electric dipoles exist in ferroelectric materials. One common ferroelectric material is lead zirconate titanate (Pb[ZrₓTi₁₋ₓ]O₃0<x<1, also referred to herein as PZT). PZT is a ceramic perovskite material that has a spontaneous polarization which can be reversed in the presence of an electric field.

Ferroelectric films have been proposed as promising recording media, with a bit state corresponding to a spontaneous polarization direction of the media, wherein the spontaneous polarization direction is controllable by way of application of an electric field. Ferroelectric films can achieve ultra high bit recording density because the thickness of a 180° domain wall in ferroelectric material is in the range of a few lattices (1-2 nm).

Sensing of spontaneous polarization direction in a ferroelectric media by a probe tip can be performed destructively by applying a test potential to a portion of the ferroelectric media while monitoring for displacement current. If no displacement current is detected, the portion of the ferroelectric media has a polarity corresponding to the test potential. If a displacement current is detected, the portion of the ferroelectric media has a polarity that is opposite a polarity of the test potential. The opposite polarity of the portion is destroyed once detected, and must be re-written. Detecting and subsequently re-writing the portion (where an opposite polarity of the portion is destroyed) results in reduced data throughput performance. To minimize this reduction in data throughput performance, a separate write transducer can be employed. However, the separate write transducer includes potential write cycling with each read. Repeated probing and cycling can result in cycle and/or imprint fatigue failure of the probed and cycled portion of the ferroelectric media.

Alternatively, a method of reading information from a ferroelectric media can include applying an alternating current (AC) potential to an atomic force microscope (AFM) tip in approximate contact with the media. A piezoelectric stress modulated by local polarization will form in a ferroelectric layer of the media. The piezoelectric stress can be detected synchronously with a lock-in amplifier in conjunction with a photo-diode signal of the AFM tip. Small piezoelectric responses (i.e., on the order of approximately 1 picometer per volt (pm/V)) can be extracted with relatively low noise. Detection and extraction can be relatively slow, limiting data throughput performance.

Embodiments of systems and methods for reading information from a media including a ferroelectric layer in accordance with the present invention can improve data throughput performance and reduce cycle and/or imprint fatigue failure over prior art probe-based systems. Such embodiments can apply radio frequency (RF) sensing techniques to a probe tip (also referred to herein as a tip) so that the tip acts as an antenna for detecting a low RF signal. A wavelength of recorded information associated with alternating polarization can be leveraged with scanning speed to modulate the signal frequency into the low RF range. Run length limited (RLL) coding can further be applied to constrain the spectrum of random data to the RF range. RF sensing techniques can make use of RF circuit(s) electrically associated with one or more tips to enable writing and/or reading for information storage.

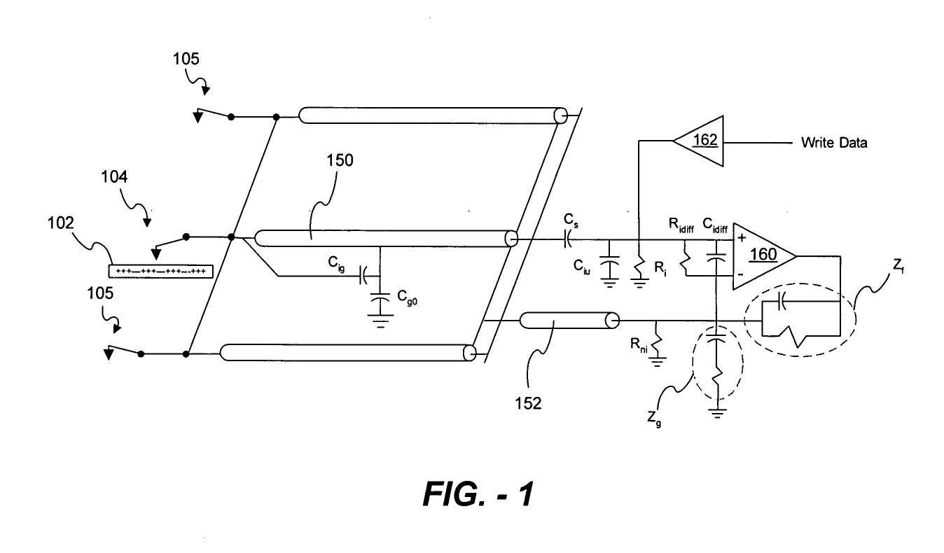

FIG. 1 is a schematic circuit diagram of a voltage mode AC-coupled front end for use in an embodiment of a system and method of storing information in accordance with the present invention. As shown, a tip 104 can be urged into near-contact with a surface of the media 102 such that the tip 104 is in electrical communication with the media 102, but not in perfect contact with the media 102. Additionally, two inactive tips 105 are shown urged away from the surface of the media 102 such that the two tips 105 are not in electrical communication with the media 102. The tips 104,105 extend from corresponding cantilevers which can extend from a common platform (or die) or multiple platforms (or die)(not shown). The active tip 104 is connected by a guarded trace (i.e., an active guard 150) to reduce noise associated with tip capacitance and cantilever capacitance. A low-noise operational amplifier (“op-amp”) 160 acts as a pre-amplifier for the circuit. The AC-coupled front end operates in quasi-differential mode when the negative input to the op-amp 160 is guarded by an active guard 152. The active guard 152 of the negative input reduces interference from external fields and can reduce a loss of RF signal, for example by mitigating loss from common mode capacitance to ground C_{g0}. Multiple guarded traces can be routed to the op-amp 160, with the number of tips that can be associated with the op-amp 160 being related to the total unguarded capacitance Cᵢᵤ of the circuit.

Capacitance associated with a cantilever can be estimated at 15 fF and capacitance associated with input routing can be estimated at up to 50 fF per millimeter with no active guard. The combined capacitance can be reduced below 50 fF with an active guard 150. Where an active guard 150 is used, capacitance of the unguarded portion of the cantilever can be accounted for in the total unguarded capacitance, Cᵢᵤ. Capacitance of the guarded input routing, C_{ig}, and the common mode capacitance to ground for the active guard 150, C_{g0}, are shown schematically. The active guard 150 can be approximately equivalent to an input voltage for a high gain op-amp 160 so that there is little or no current in the guarded input routing capacitance, C_{ig}. The active guard 150 need not employ a separate voltage-follower amplifier, and therefore can introduce less noise relative to a front-end having a separate voltage-follower amplifier.

The total unguarded capacitance, Cᵢᵤ, can include the op-amp 160 and write amplifier 162 capacitances, as well as interconnect capacitance. Rᵢ is the common mode input resistance and Rₙᵢ is the common mode resistance for the negative input terminal of the op-amp 160. The differential input components, R_{idiff} and C_{idiff}, become negligible and can be ignored for sufficiently high gain op-amps. Optionally, an AC-coupling capacitor, Cₛ, can be included to reduce noise and act as a high-pass filter. The AC-coupling capacitor, Cₛ, is transparent where its capacitance is much greater than a combined capacitance associated with the cantilever and the tip. A tip can float electrically if desired where the ac-coupling capacitor, Cₛ, is transparent.

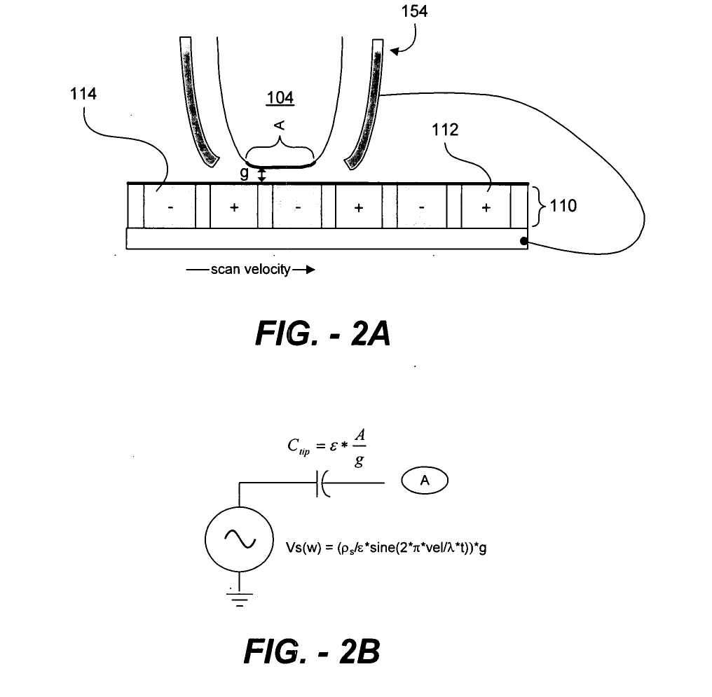

A charge coupled from the ferroelectric layer of the media to the tip 104 causes a polarization signal in the form of displacement current and/or sensed voltage (or voltage potential). The polarization signal can be monitored to identify information stored in the media. The charge coupled from the ferroelectric layer of the media to the tip 104 can be estimated as the product of the effective surface charge density of the ferroelectric layer and the effective area of the tip 104. Referring to FIGS. 2A-2C, a charge can be modeled as an AC-source with the tip capacitance. The tip capacitance can be modeled using the equation:

$${C}_{tip} = ɛ * \frac{A}{g}$$

where g is the effective tip gap to the effective surface charge of the media, A is the effective area of the tip, and ε is the permittivity of the gap. The equation is a usable estimate where g is on the order of \sqrt{A}. The model is a simplification that can avoid solving complicated three-dimensional field equations.

Referring to FIG. 2A, a cross-sectional representation is shown of a tip 104 arranged over a media 102 for monitoring a spontaneous polarization of a ferroelectric layer 110 (e.g. PZT) of the media 102. The ferroelectric layer 110 includes regions having positive spontaneous polarization 112 and negative spontaneous polarization 114, with transitions between regions, although in other embodiments, domains including regions of generally homogenous spontaneous polarization can abut one another. In such other embodiments, an increase in desired areal density can result in a desire to reduce or eliminate transitions. The tip 104 is shown in close proximity with the surface of the media 102 such that the tip 104 is affected by the spontaneous polarization of the domains. In an embodiment, the gap g can be sized to approximately match a thickness of the ferroelectric layer 110.

Referring to FIG. 2B, an equivalent circuit is shown representing the model of FIG. 2A. The equivalent circuit employs a capacitor analogy to determine a charge over which the effective area A of the tip 104 is arranged based on a potential of a capacitor (Cₜᵢₚ). A simplified approximation of voltage potential across the media 102 can be made based on the equation:

$$V = \frac{Q}{{C}_{tip}}$$

where Q is the surface charge under the effective area of the tip. The surface charge is the product of the effective surface charge density, ρₛ, and the effective area, A. With substitution for Q and Cₜᵢₚ, the equation can be written as:

$$V = {ρ}_{s} * \frac{g}{ɛ}$$

If the effective tip gap to the effective surface charge of the media does not vary substantially enough to produce an intolerable signal-to-noise ratio, the voltage potential will vary with the ratio of ρₛ, to ε.

The equation above is given for a static charge; however, the charge is effectively a “moving charge”, varying from positive polarization to negative polarization as the tip 104 moves relative to the media 102 at a velocity, υ, over the media 102. The polarization signal therefore resembles alternating current and the media 102 can be modeled as an AC source. An approximation of the voltage for the first harmonic of such an AC source can be made with the equation:

$${V}_{S} ( w ) = {ρ}_{s} sin ( \frac{2 π υ}{λ} * t ) * \frac{g}{ɛ}$$

wherein w is a width of the effective domain, λ is the “wavelength” across a positively polarized domain and a negatively polarized domain (as shown in FIG. 2C), and t is a period.

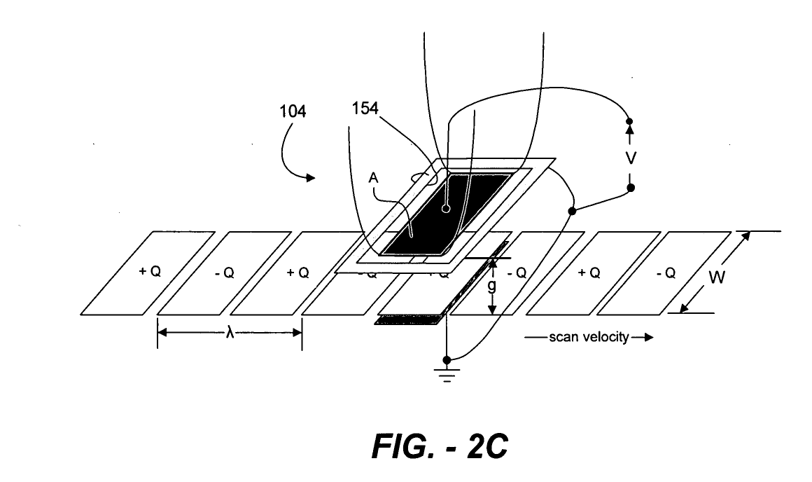

The equivalent circuit and the equation for voltage source can be substituted into the schematic partial circuit diagram shown in FIG. 1. A simplified circuit diagram is shown in FIG. 3A. Referring to FIG. 3B, Z_{f} and Z_{g} set the operational bandwidth of the circuit. When the circuit is operated at frequency ω within a target frequency range f₀ to f₁, feedback impedances Z_{f} and Z_{g} are reduced to resistances R_{f} and R₀, which set the in-band gain. In an embodiment, f₀ can be approximately 200 KHz and f₁ can fall approximately between 10 and 15 MHz. The input voltage at the op-amp can be estimated by the equation:

$${V}_{i n} = \frac{{ρ}_{s} ( ω ) * A}{{C}_{iu}} * \frac{( j * ω * {R}_{i} * {C}_{iu} )}{1 + ( j * ω * {R}_{i} * {C}_{iu} )}$$

The input voltage is roughly a product of charge density as a function of the frequency and the effective area A, divided by the unguarded input capacitance Cᵢᵤ. Increasing the effective area A, for example by widening the tip in the cross-track direction, can increase a signal coupled to the tip, thereby easing servo control. Reducing the unguarded input capacitance Cᵢᵤ can substantially increase an influence of the charge density, thereby improving charge detection. The unguarded input capacitance Cᵢᵤ can be reduced by increasing the active guard. For example, a guard can be extended distally as far as is practicable to the effective area. Additionally, use of an extended guard can improve immunity to external fields and can reduce fringing to/from adjacent marks or bits thereby improving the spatial resolution of the tip. Such an extended guard 154 is shown schematically in FIGS. 2A and 2B. In an embodiment, the extended guard 154 can be formed by depositing alternating metal and dielectric layers on the conductive tip. A distal end of the tip can be polished or clipped to expose the tip.

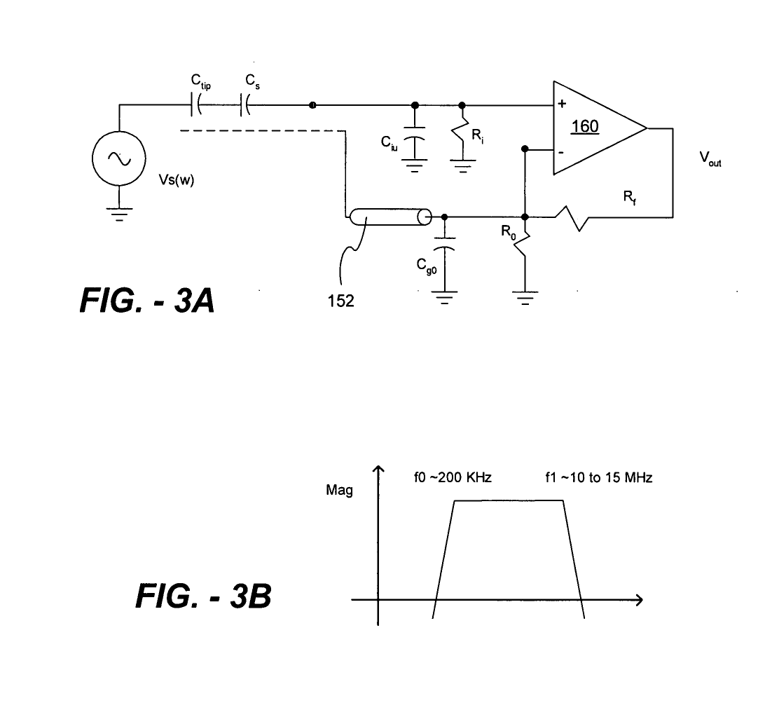

Noise sources within the circuit of FIG. 3A include the op-amp input, the voltage source, and the resistors within the circuit. Referring to FIG. 4, a plot of estimated noise figure as a function of the unguarded input capacitance Cᵢᵤ is illustrated for a media having a signal-to-noise ratio of 15 decibels (dB). An ideal op-amp that adds no noise to the input signal would have a 0 dB noise figure. As can be seen, an unguarded capacitance limited to approximately 500 fF will result in a loss in signal-to-noise ratio of less than 1 dB. To achieve such results, the input noise current for the op-amp can be kept low relative to the input noise voltage, and the input impedance can be kept relatively high. Embodiments of systems and methods in accordance with the present invention can employ a field-effect transistor (FET)-based or complementary metal-oxide semiconductor (CMOS)-based op-amp to achieve acceptable results.

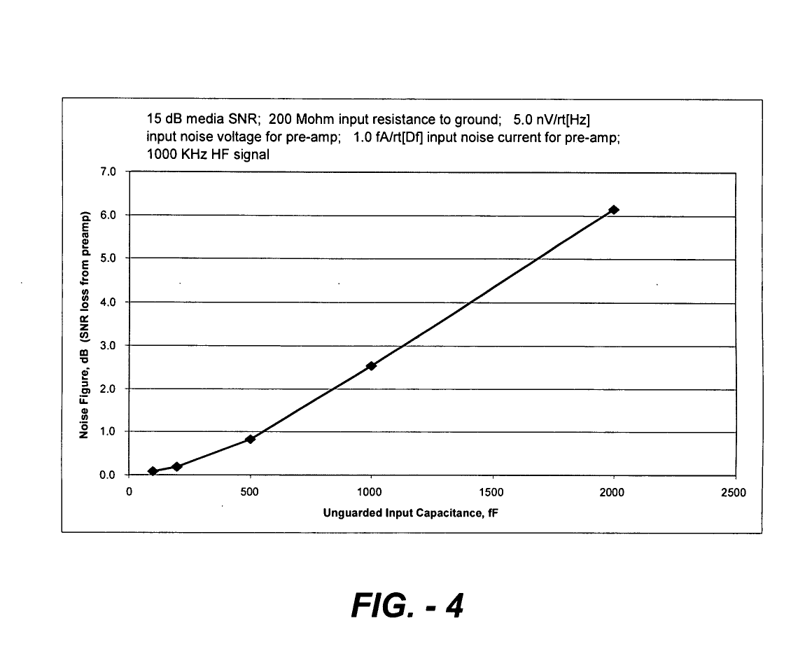

FIG. 5 is a schematic circuit diagram of a charge mode AC-coupled front end for use in alternative embodiments of systems and methods of storing information in accordance with the present invention. As shown, a tip 204 can be urged into near-contact with a surface of the media 202 such that the tip 204 is in electrically communication with the media 202, but not in perfect contact with the media 202. Additionally two tips 205 are shown urged away from the surface of the media 202, and not active. The active tip 204 is connected by an active guard 250 with a common interconnect so that multiple guarded traces can be routed to a first stage op-amp 260. The active guard 250 is further connected to ground. An AC-coupling capacitor Cₛ is arranged in series with the common interconnect. The first stage op-amp 260 acts as a trans-impedance amplifier having low input impedance that substantially guards stray impedances to ground, thereby providing a virtual ground. As shown, a grounded active guard 252 protects the positive input to the first stage op-amp 260 from interference from stray electric fields, while the virtual ground at the negative input of the first stage op-amp 260 makes signal amplitude insensitive to common mode input capacitance and resistance. A second stage op-amp 264 provides signal gain and passband shaping.

If the feedback resistance R_{f} is finite, the location of the pole of the op-amp 260 for feedback impedance can determine the mode of operation. However, if the feedback resistance R_{f} is very large or open, the DC gain for offset control is limited and the feedback resistance R_{f} mitigates noise. Thus, the feedback resistance R_{f} can be ignored where feedback resistance R_{f} is large, as in charge mode operation, and the output voltage of the first stage Vₒ₁ is reduced to the equation:

$${V}_{o 1} = \frac{{ρ}_{s} ( ω ) * A}{{C}_{f}}$$

With the feedback resistance R_{f} ignored, the output voltage of the first stage Vₒ₁ can be controlled by way of the feedback capacitance C_{f}.

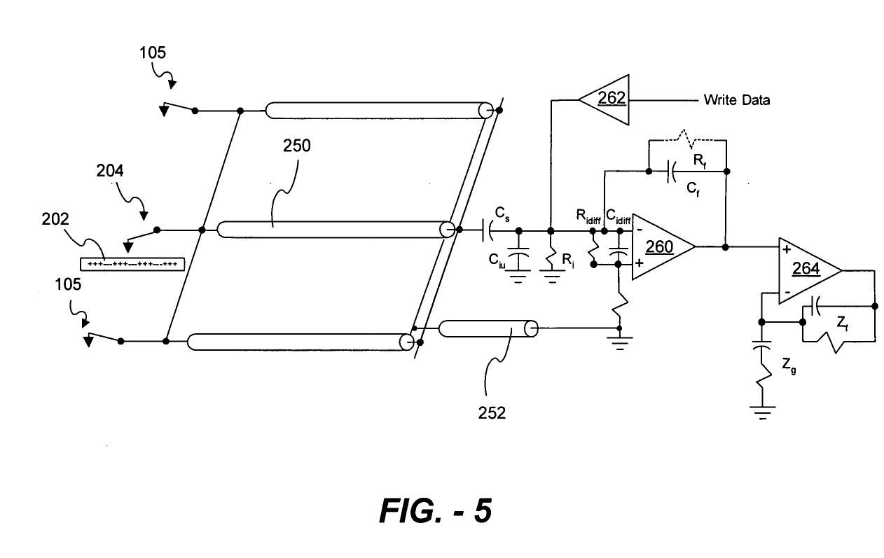

As above, the moving charge can be modeled as an AC-source with the tip capacitance. The tip capacitance can be modeled using the same equation. A simplified circuit diagram is shown in FIG. 6, eliminating components having negligible effect on the signal and substituting the equivalent circuit of FIG. 2A and the equation for voltage source into the schematic partial circuit diagram shown in FIG. 5. The signal amplitude depends inversely on the feedback capacitor C_{f} in the first stage op-amp 260. As above, feedback resistances R_{f} and R₀ set the in-band gain.

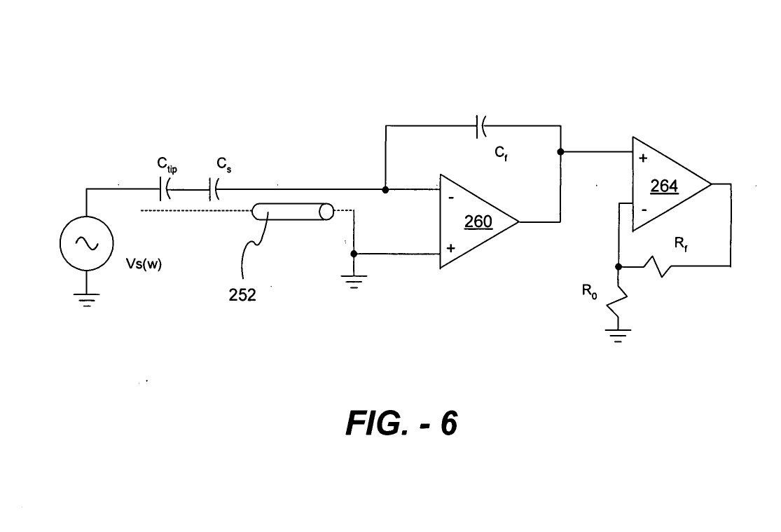

Noise sources within the circuit of FIG. 6 include the op-amp input, the voltage source, the resistors within the circuit, and the input noise voltage for the second stage. Referring to FIG. 7, a plot of estimated noise figure as a function of the feedback capacitance C_{f} is illustrated for a media having a signal-to-noise ratio of 15 decibels (dB). An ideal op-amp that adds no noise to the input signal would have a 0 dB noise figure. As can be seen, a feedback capacitance Cf limited to approximately 750 fF will result in a loss in signal-to-noise ratio of less than 1 dB. As above, to achieve such results, the input noise current for the first stage op-amp 260 can be kept low relative to the input noise voltage, and the input impedance can be kept relatively high, therefore a field-effect transistor (FET)-based or complementary metal-oxide semiconductor (CMOS)-based op-amplifier can be used.

As mentioned above, embodiments of systems and methods in accordance with the present invention can comprise a tip platform including a plurality of cantilevers extending from the tip platform, a plurality of tips extending from corresponding cantilevers for accessing the media. The media can be associated with a media platform. One or both of the tip platform and the media platform can be moveable so as to allow the tips to access an amount of the media desired given the number of tips employed. Systems and methods having suitable structures for positioning a media relative to a plurality of tips are described, for example, in U.S. patent application Ser. No. 11/553,435 entitled “Memory Stage for a Probe Storage Device”, filed Oct. 6, 2006 and incorporated herein by reference.

Preferably, the one or more tips are positioned so that a gap exists between the media surface and the tips, while being in sufficiently close proximity to the media surface that the tips can detect a signal. In a preferred embodiment, positioning of the tip can produce a contact force of 200 nano-newtons (nN) or less, although in other embodiments the contact force can be less than 500 nano-newtons. Reducing a contact force applied to the tips can reduce tip wear to improve a lifetime of the probe data storage device and potentially improve scan speed.

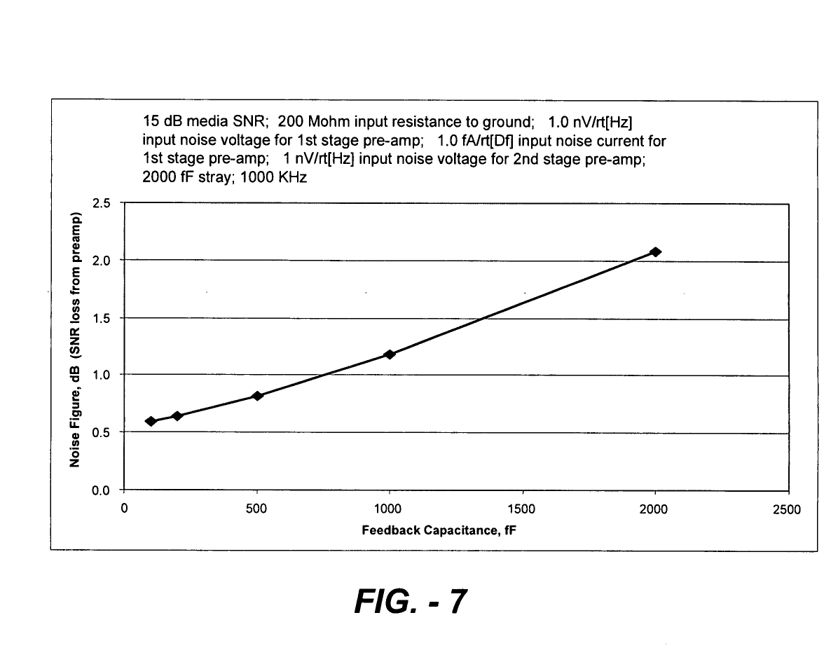

FIG. 8 is a schematic circuit diagram of a front end including a guard trace 350 electrically connected with a second op-amp 366 for use in alternative embodiments of systems and methods of storing information in accordance with the present invention. The op-amp 160 of FIG. 1 can be sensitive to stray electric fields that pass through the unshielded cantilever or tip trace. Shielding provided by the active guard may be reduced due to process and architectural fabrication considerations. In such circumstances, the stray electric fields can be problematic for detecting the spontaneous polarization of the ferroelectric domains. Embodiments of systems and methods can apply a differential mode circuit to reduce an affect of stray electric fields when reading the ferroelectric media.

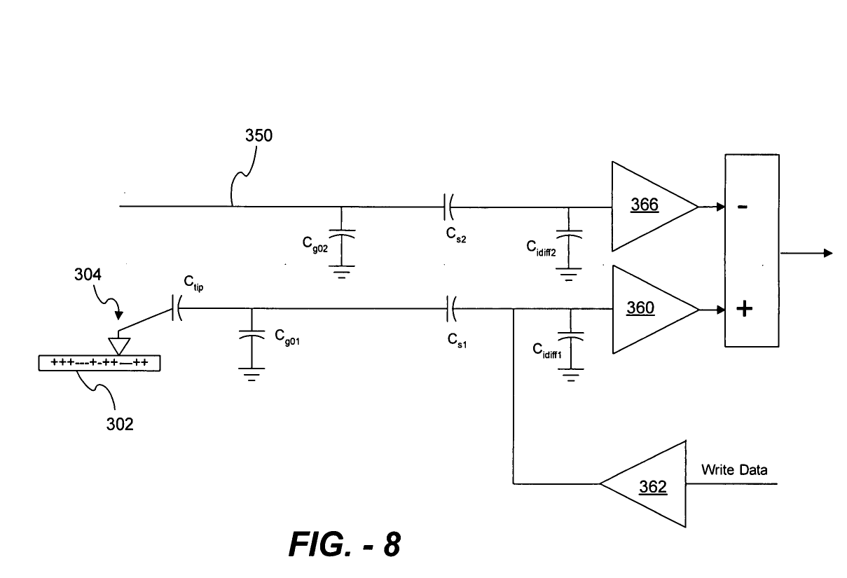

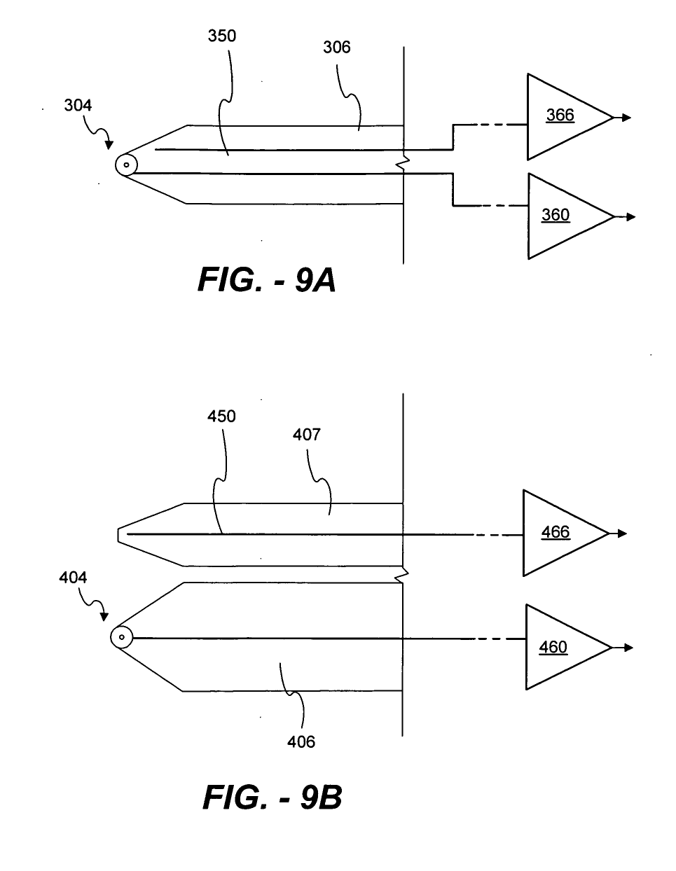

The guard trace 350 associated with the second op-amp 366 can be routed alongside of the trace connected with the tip 304. As shown in FIG. 9A, the guard trace 350 is routed along the cantilever 306 in close proximity to the tip trace. However, the guard trace need not be routed along the cantilever 306, but can be arranged to provide a sufficiently similar detection of stray electric field as the tip trace. As shown in FIG. 9B, the guard trace 450 can extend along a second cantilever 407 arranged in close proximity to the first cantilever 406 from which the tip 404 extends. Stray electric fields that can interfere with detection of spontaneous polarization and that are common to both the guard trace and the tip trace can be canceled by forming the difference between the two op-amp 360,366 outputs. For example, loss of RF signal from common mode capacitance to ground C_{g01} and differential input capacitance C_{idiff1} can be reduced by the guard trace 350 which generally exhibits similar common mode capacitance to ground C_{g02} and differential input capacitance C_{idiff2}, and which therefore can beneficially serve to cancel out such detrimental effects.

As with the active guard arrangement of FIGS. 1 and 5 above, the differential mode circuit of FIG. 8 can use voltage or charge op-amps as read pre-amplifiers. Optionally, AC-coupling capacitor, Cₛ₁ and Cₛ₂, can be included to reduce noise and act as high-pass filters. The AC-coupling capacitor, Cₛ, is transparent where its capacitance is much greater than a combined capacitance associated with the cantilever and the tip, Cₜᵢₚ. A tip can float electrically if desired where the ac-coupling capacitor, Cₛ, is transparent.

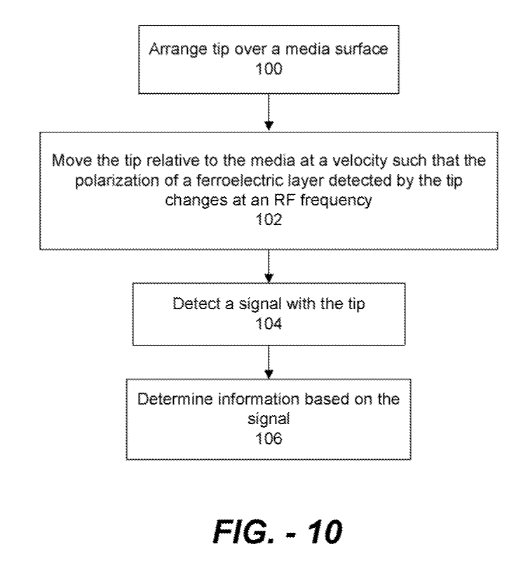

Referring to FIG. 10, an embodiment of a method of reading information stored in a ferroelectric layer of a media in accordance with the present invention can include arranging a tip over a media surface so that the tip is in electrical communication with the ferroelectric layer (Step 100) and moving the tip across the media surface at a velocity such that a polarization of the ferroelectric layer as detected by the tip changes at a frequency within a low RF frequency range (Step 102). A polarization signal is detected by the tip (Step 104), and information is determined based on the polarization signal (Step 106).

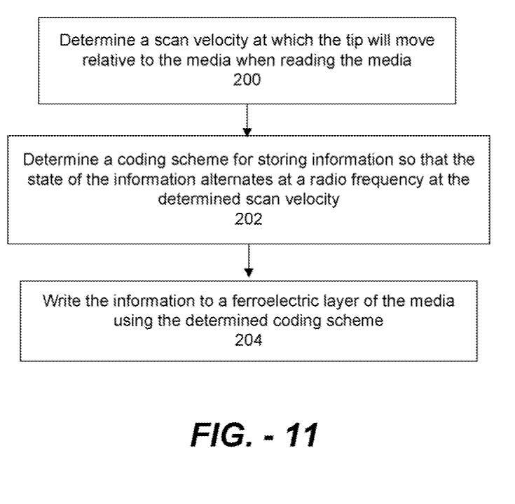

Referring to FIG. 11, an embodiment of a method of reading information stored in a ferroelectric layer of a media in accordance with the present invention can include determining a scan velocity at which the tip will move relative to the media when reading the media (Step 200) and determining a coding scheme for storing information so that the digital state of the information alternates at a low RF frequency to the tip moving at the determined scan velocity (Step 202). Information is then written to a ferroelectric layer of the media by implementing the determined coding scheme (Step 204).

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A system for storing information, comprising:
a media including a ferroelectric layer;
a tip arrangeable in electrically communicative proximity to the media; and
circuitry to detect a polarization signal having a radio frequency;
wherein the polarization signal corresponds to changes in polarization of domains of the ferroelectric layer at a velocity of movement between the tip and the media;
wherein a domain of polarization of the ferroelectric layer is information.

2. The system of claim 1, wherein:
the ferroelectric layer includes information encoded so that a frequency of the polarization signal generated by the information is a radio frequency.

3. The system of claim 1, wherein:
the ferroelectric layer includes information encoded so that a frequency of the polarization signal generated by the information is within a portion of a band including the radio frequencies.

4. The system of claim 1, further comprising:
a platform;
a cantilever extending from the platform; and
wherein the tip extends from the cantilever;
wherein the circuitry includes a preamplifier comprising an operational amplifier; and
wherein at least a portion of the cantilever includes an active guard.

5. The system of claim 4, further comprising:
a plurality of cantilevers extending from the platform; and
a plurality of tips extending from corresponding cantilevers;
wherein the plurality of tips are electrically associated with the operation amplifier.

6. The system of claim 1, further comprising:
an active guard extending over at least a portion of the tip.

7. A system for storing information, comprising:
a media including a ferroelectric layer with a plurality of domains of polarization;
an antenna arranged in detectable proximity of the plurality of domains, the antenna being moveable relative to the media;
wherein the antenna can detect a polarization signal generated by changes in polarization of the plurality of domains as the antenna moves relative to the media.

8. The system of claim 7, wherein the polarization signal has a radio frequency.

9. The system of claim 7, wherein the plurality of domains are encoded so that when the antenna moves approximately at a scan velocity relative to the media, changes in polarization of the plurality of domains occur within a range of radio frequencies.

10. The system of claim 7, wherein the antenna is a tip extending from a cantilever.

11. The system of claim 1, wherein the ferroelectric layer is PZT.

12. A method of reading information stored in a ferroelectric layer of a media with a tip, the method comprising:
arranging the tip over the media so that the tip is in electrical communication with the media;
moving one of the tip and the media at a velocity such that a polarization of the ferroelectric layer positioned at the tip changes to appear to the tip as a polarization signal having a radio frequency;
detecting the polarization signal; and
determining information based on the signal.

13. The method of claim 12, wherein the information is encoded so that the polarization signal has a frequency within a portion of the band of radio frequencies.

14. The method of claim 12, wherein the ferroelectric layer is PZT.

15. A method of writing information to a ferroelectric layer of a media, the method comprising:
determining a scan velocity at which a tip will move relative to the media when reading the information from the ferroelectric layer;
determining a coding scheme for storing the information so that the state of the information alternates within a band of radio frequency at the determined scan velocity; and
writing information to the ferroelectric layer using the determined coding scheme.

16. The method of claim 15, wherein the ferroelectric layer is PZT.
